(19) United States
(12) Patent Application Publication
(10) Pub. No.: US 2023/0021465 A1
(43) Pub. Date: Jan. 26, 2023

(54) USER AVAILABILITY DETECTOR

(71) Applicant: VMWARE, INC., Palo Alto, CA (US)

(72) Inventors: Kar-Fai Tse, Atlanta, GA (US); Ramanandan Nambannor Kunnath, Bangalore (IN); Rohit Pradeep Shetty, Bangalore (IN)

(21) Appl. No.: 17/499,899

(22) Filed: Oct. 13, 2021

(30) Foreign Application Priority Data
Jul. 23, 2021 (IN) 202141033282

(51) Int. Cl. G06Q 10/10; G06Q 10/06; H04L 29/08

(52) U.S. Cl. CPC G06Q 10/1095; G06Q 10/1091; G06Q 10/06312; H04L 67/24

(57) ABSTRACT

Disclosed are various approaches for detecting user availability. A work pattern can be generated based upon user activity data taken from various sources. A work pattern can be provided to an email client or another requesting service for predicted availability of a user.

### RELATED APPLICATION

Benefit is claimed under 35 U.S.C. 119(a)-(d) to Foreign Application Serial No. 202141033282 filed in India entitled “USER AVAILABILITY DETECTOR”, on Jul. 23, 2021, by VMware, Inc., which is herein incorporated in its entirety by reference for all purposes.

### BACKGROUND

In an enterprise setting, meetings are often organized using an email or calendar client that can be integrated with a user's availability and unavailability. The user's availability for meetings can be shared within an enterprise and through an external service so that other users wishing to schedule a meeting with the user can do so while seeing when the user might be unavailable due to other meetings or conflicts.

However, partial or full visibility into other meetings or conflicts does not necessarily provide a full picture of the user's availability for meetings. For example, users might be spread across different time zones, so a morning meeting for one user might mean a late-night meeting for another user. Some users may not have meetings or conflicts for certain time windows, but the user might generally be unavailable simply because they are not generally working at certain hours of the day. Even when users are in the same or similar time zones, different users may keep wildly different work schedules for various personal or professional reasons. For example, one user might begin the workday at 5 am and end the workday at 3 pm, while another user might be a “night-owl” and begin the workday at noon, ending the workday at 8 pm.

However, meeting availability provided by an email or calendar client that is based upon scheduled meetings or conflicts may not taken varying work schedules into account. Certain calendar clients may attempt to provide a hint to a scheduling user that is based on a generalized start to the workday, but these hints are generally not personalized to the user that is being invited to a meeting. Accordingly, scheduling meetings

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram depicting an example implementation according to various examples of the disclosure.

FIG. 2 is an illustration of user activity data that can be collected in examples of the disclosure.

FIG. 3 is an illustration of quantized user activity data that can be collected in examples of the disclosure.

FIG. 4 is a flowchart that illustrates functionality according to an example of the disclosure.

### DETAILED DESCRIPTION

Disclosed are examples of a system that detection of user activity in an enterprise setting. The user activity data can be utilized to predict user availability or to predict when a user is likely working. In other words, examples of the disclosure can detect a user's likely working hours.

Users within an enterprise often use calendar systems to propose and schedule meetings between users. User availability can be shared using email or calendar servers and clients so that users can visualize the availability of users that are being invited to a meeting before a meeting time is selected by the meeting organizer. A calendar and/or email client can generate an email with a meeting invitation embedded or attached to the email. The email can be circulated by the email client and the users' respective email services to the recipients, who can accept or deny the invitation.

Certain email clients or email servers can provide suggested unavailability times for users who are being invited to a meeting. In this scenario, the suggested unavailability times are typically not personalized to the work schedule of the user, which might vary by the day and might vary user-by-user. For example, a first user might be a night owl that begins their workday much later than a second user who is an early riser. However, providing the same suggested availability for each user might be inaccurate for certain users who keep differing work schedules.

In some cases, users might opt to share their entire calendars with other users. In this scenario, the shared calendar might show when the user has a scheduled conflict, but the shared calendar may not communicate the typical working schedule of the user. A typical working schedule of the user is often not expressed on a user's calendar like scheduled meetings or scheduled conflicts. Accordingly, if a user is invited to a meeting outside of his or her typical work schedule, the user might decline the invitation even though the requested meeting time was not during a scheduled conflict of the user and within the suggested availability times generated by the calendar client.

Examples of this disclosure can include a user availability detector that can generate a predicted work schedule or work pattern of a user. The predicted work pattern can be utilized for various purposes. In one example, the predicted work pattern can be utilized to provision information technology (IT) resources such a virtual desktop infrastructure (VDI) resources based upon when users are expected to require them. In another example, the predicted work pattern can be utilized to generate recommended availability for a meeting assuming that a user opts to share his or her work pattern with other users within an enterprise.

A work pattern can be generated based upon an analysis of user activity through various channels. User activity can be assessed through use of enterprise applications, network activity through a virtual private network (VPN) tunnel, activity detected through a single sign-on (SSO) service or identity manager, through VDI activity detected for the user, and device metrics that can be collected from a client device that is managed by a management service.

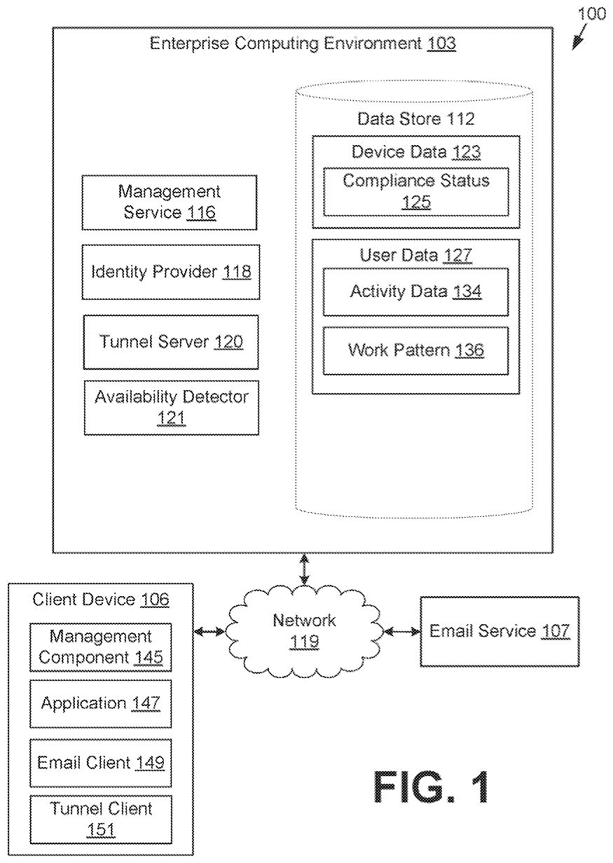

FIG. 1 illustrates an example of a networked environment 100 according to examples of the disclosure. In the depicted network environment 100, an enterprise computing environment 103 is in communication with at least one client device 106 and an email service 107 over a network 119.

The network 119 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The enterprise computing environment 103 can be a computing environment that is operated by an enterprise, such as a business or other organization. The enterprise computing environment 103 includes a computing device, such as a server computer, that provides computing capabilities. Alternatively, the enterprise computing environment 103 can employ multiple computing devices that are arranged in one or more server banks or computer banks. In one example, the computing devices can be located in a single installation. In another example, the computing devices for the enterprise computing environment 103 can be distributed among multiple different geographical locations. In one case, the enterprise computing environment 103 includes multiple computing devices that together can form a hosted computing resource or a grid computing resource. Additionally, the enterprise computing environment 103 can operate as an elastic computing resource where the allotted capacity of computing-related resources, such as processing resources, network resources, and storage resources, can vary over time. In other examples, the enterprise computing environment 103 can include or be operated as one or more virtualized computer instances that can be executed to perform the functionality that is described herein.

Various applications or other functionality can be executed in the enterprise computing environment 103. Also, various data can be stored in a data store 112 that can be accessible to the enterprise computing environment 103. The data store 112 can be representative of a plurality of data stores 112. The data stored in the data store 112 can be associated with the operation of the various applications or functional entities described below.

The components executed on the enterprise computing environment 103 can include a management service 116, an identity provider 118, a tunnel server 120, an availability detector 121 and other applications, services, processes, systems, engines, or functionality not discussed in detail herein. The management service 116 can be executed in the enterprise computing environment 103 to monitor and oversee the operation of one or more client devices 106 by administrators. In some examples, the management service 116 can represent one or more processes or applications executed by an enterprise mobility management (EMM) provider that facilitates administration of client devices 106 of an enterprise that are enrolled with the EMM provider. To this end, the operating system and application ecosystem associated with the client device 106 can provide various APIs and services that allow client devices 106 to be enrolled as managed devices with the management service 116.

The management service 116 can include a management console that can allow administrators to manage client devices 106 that are enrolled with the management service 116. User interfaces can allow an administrator to define policies for a user account or devices associated with an enterprise environment. The user interfaces can also include, for example, presentations of statistics or other information regarding the client devices 106 that can be managed by the management service 116.

The enterprise computing environment 103 can also execute an identity provider 118. The identity provider 118 can carry out federated user authentication on behalf of an enterprise. For example, the identity provider 118 can implement OAuth, SAML, or similar protocols that allow for federated user authorization or authentication. In examples of this disclosure, the identity provider 118 can also verify a user-and-device token provided by a client device 106 to provide multi-device SSO capabilities as described herein. The identity provider 118 can verify a user's credentials or identity and provide an authentication token, such as a SAML assertion, that can be provided to an application service 107 by an application on a client device 106 to authenticate the user's access to a service provided by the application service 107. The identity provider 118 can issue the authentication token to a client device 106 after verifying the identity of the user and/or client device 106 from which the user is attempting to access the application service 107. In the context of this disclosure, once a user has authenticated his identify from a first device, the identity provider 118 can authenticate the user from a second device that is managed by the management service 116 upon receiving a user-and-device token from the second device, where the user-and-device token can be verified by the identity provider 118.

The identity provider 118 can verify a user-and-device token issued by the management service 116 to a client device 106 that is enrolled as a managed device and that is associated with a particular user account. The user-and-device token can include information that allows the identity provider 118 to verify the user as well as the device. The user-and-device token can be signed so that the identity provider 118 can verify the authenticity of the token itself. If the user has already established his identity with the identity provider 118 from a first device, and the identity provider 118 subsequently receives a user-and-device token from a second device, the identity provider 118 can establish a SSO session with the second device if the user-and-device token can be validated. Validation can be performed by verifying the signature applied to the user-and-device token as well as the user and device identifying information contained within the token.

In some embodiments, the identity provider 118 can be implemented in a separate computing environment or by a separate entity than the management service 116. The management service 116 can provide an application programming interface (API) with which the identity provider 118 can communicate to verify a user-and-device token or to obtain a public key with which the signature of a user-and-device token can be verified. The management service 116 can also provide an API through which the identity provider 118 can verify user identifiers or device identifiers that are embedded within a user-and-device token.

The 116/ and/or 118/ can also receive application usage data from applications or a management component installed on the client device 106. Applications on the client device 106 can report time and date information associated with application usage. Additionally, cloud-based services can report login and logout information to the 116/ or 118/. A SSO client application that operates as a hub to access enterprise applications can be installed on a client device 106 and report usage of enterprise applications to the 116/ or 118/.

The 116/ or 118/ can also obtain usage of VDI resources associated with a user from a VDI infrastructure environment. A VDI infrastructure environment can utilize the 118/ for identity management and also report usage data to the 116/ in some instances.

The tunnel server 120 can provide a virtual private network connection, or a VPN tunnel to an enterprise or private network. The VPN tunnel can be provided to client devices associated with users of the enterprise. The VPN tunnel can be initiated by a tunnel client running on a client device 106 and terminated at the tunnel server 120. The tunnel server 120 can utilize TLS, SSL, or other encryption methodologies to secure a network connection between the 106/ and the 120/. The network connection can also be specific to certain apps that are running on the 106/, such as a tunnel client or other applications on the 106/ that utilize per-app VPN capabilities of an operating system on the client device 106.

The availability detector 121 can analyze usage data associated with users of the enterprise and generate a predicted availability of the user. The predicted availability can also be referred to herein as a work pattern. A predicted availability of the user can be based upon when a particular user is observed working using enterprise resources for which access is managed by the 116/ and/or 118/. The availability detector 121 can compute the work pattern of a user based upon observation of previous behavior. For example, behavior over a period of time can be observed and a work pattern can be calculated based upon the observed behavior. The work pattern can represent a predicted starting time and ending time for a workday of a user. The work pattern can also include predicted breaks during the day, such as for lunch or other breaks during the day. The work pattern can also include confidence indicators or scores for the various quanta of time during the day that indicate a confidence level that the user is working at a particular time in a day.

Work patterns can be stored in the data store 112 in association with a user. The availability detector 121 can update the work pattern of a user periodically, such as according to a regular schedule or whenever an email client requests to add the user to a meeting or event.

The data stored in the data store 112 can include device data 123, user data 127, and potentially other data. Device data 123 can include records to client devices 106 that are enrolled as managed devices with the management service 116. A record within device data 123 can include various security settings selected for enforcement on a client device 106 that is enrolled with the management service 116. Accordingly, a device record can include a device identifier associated with a device, such as the client device 106 and other data associated with managed devices. In some examples, device data 123 can also identify a user associated with or assigned to a particular client device 106. A device record can also store other device specific information, such as a device type, operating system type or version, applications that are required or optional for the device, or an enrollment status of the device. In this scenario, the device data 123 can also indicate whether a managed device is a computing device or a peripheral device, such as a printer, scanner, or other device that can be deployed in an environment and associated with a record in a directory service.

A compliance status 125 of a client device 106 represents whether the device is in compliance with one or more compliance rules. Various compliance rules can be enforced by the management service 116 by the client device 106. Compliance rules can be based on time, geographical location, or device and network properties. For instance, the client device 106 can satisfy a compliance rule when the client device 106 is located within a particular geographic location. The client device 106 can satisfy a compliance rule in other examples when the client device 106 is in communication with a particular local area network, such as a particular local area network that is managed by the enterprise computing environment 103. Furthermore, a compliance rule in another example can be based upon the time and date matching specified values.

A compliance rule can specify that a client device 106 is required to be off or in a low power “sleep” state during a specified time period. Another compliance rule can specify that a client device 106 is required to be on or in a normal operation “awake” state during a specified time period. As another example, a compliance rule can specify that a client device 106 is prohibited from rendering content that has been designated as confidential.

Another example of a compliance rule involves whether a user belongs to a particular user group. For instance, a compliance rule can include a whitelist or a blacklist that specifies whether particular users or groups of users are authorized to perform various functionalities, such as installing or executing a particular application.

Other examples of compliance rules include a rule that specifies whether a client device 106 is compromised or “jailbroken.” For example, a client device 106 can have hardware or software protections in place that prevent unauthorized modifications of the client device 106. If these protections are overridden or bypassed, the client device 106 can be considered out of compliance. As another example, a compliance rule can specify that the client device 106 is required to prompt a user for a password or personal identification number (PIN) in order to unlock the device.

A compliance rule can also require that the client device 106 have device encryption enabled, where data stored on the device is stored in an encrypted form. The data can be encrypted by a device certificate. A compliance rule can also specify that the client device 106 is enrolled with the management service 116 as a managed device. Another compliance rule can specify that the user is required to accept the terms of service that are presented by the management component 145 on the client device 106. As another example, a compliance rule can specify that the management component 145 is required to periodically communicate or “check-in” with the management service 116 to report on its status. If a threshold amount of time has elapsed since the previous check-in of the client device 106, the device can be considered to have violated this compliance rule.

Another compliance rule can specify that a client device 106 be running one of a specified variants or versions of a particular operating system. A compliance rule can also specify that an enrolled device be manufactured by a particular manufacturer or have a particular manufacturer identifier. Another compliance rule can specify that an enrolled device be a particular model name or model number. A client device 106 can also be considered out of compliance if the device is in a data roaming mode or has used a threshold amount of a periodic network data usage allowance.

Accordingly, the compliance status 125 indicates whether and to what extent a particular client device 106 is compliant with compliance rules assigned to the client device 106 by the management service 116. The compliance status 125 can be determined by a management component 145 on the client device 106 that analyzes the status of the client device 106 and reports compliance to the management service 116. In other examples, the compliance status 125 can be determined by the management service 116 based upon information about the status of the client device 106 that is reported by the management component 145.

User data 127 contains information about user accounts in a user directory. User accounts can be maintained by a directory service or the identity provider 118. The user accounts can be associated with client devices 106 that are enrolled with the management service 116. The user data 127 can be associated the same user accounts that are verified by the identity provider 118. In some implementations, the identity provider 118 can rely upon a separate set of user account data or a user directory to determine whether to issue an authentication token to an application on behalf of the user. In other implementations, the user data 127 is a user directory associated with the identity provider 118, and the management service 116 accesses the user data 127 through an API provided by the identity provider 118.

User data 127 can include profile information about a user, authentication information about a user, applications that are installed on client devices 106 associated with the user, and other user information. For example, user data 127 can include information about client devices 106 that are associated with a user account of the user, enterprise resources to which a particular user has access, such as email, calendar data, documents, media, applications, network sites, or other resources. The user data 127 can also identify one or more user groups of which a particular user is a member, which can in turn define the access rights of the user to one or more enterprise resources as well as identify which applications should be deployed to a client device 106 associated with the user. To this end, the user data 127 can further identify one or more device identifiers that can uniquely identify client devices 106 that are associated with a user account of the user.

User data 127 can also include activity data 134 and a work pattern 136. Activity data 134 can represent usage data that can be collected by the management service 116, identity provider 118, tunnel server 120, and management component 145. Activity data 134 can represent network activity, such as via the tunnel server 120, application usage data, usage data as determined by activity on the identity provider 118 and other indications that a user is potentially working or using enterprise information technology resources.

A work pattern 136 represent a predict work schedule generated for a user based upon the activity data 134. The work pattern 136 can be generated by the availability detector 121. The work pattern 136 can identify days of the week, at least one start time, and at least one end time. The work pattern 136 can also represent a heat map that represents a confidence indication for particular times of day that the user is expected to be working. For example, on days and times where a confidence level is high that the user is working, the work pattern 136 can express with a higher degree of certainty that the user is working compared to other days and times where the confidence level is lower.

The email service 107 can be a computing environment that is operated by an enterprise, such as a business or other organization. The email service 107 includes a computing device, such as a server computer, that provides computing capabilities. Alternatively, the email service 107 can employ multiple computing devices that are arranged in one or more server banks or computer banks. In one example, the computing devices can be located in a single installation. In another example, the computing devices for the email service 107 can be distributed among multiple different geographical locations. In one case, the email service 107 includes multiple computing devices that together can form a hosted computing resource or a grid computing resource. Additionally, the email service 107 can operate as an elastic computing resource where the allotted capacity of computing-related resources, such as processing resources, network resources, and storage resources, can vary over time. In other examples, the email service 107 can include or be operated as one or more virtualized computer instances that can be executed to perform the functionality that is described herein.

The email service 107 can be hosted by a third party and provide email and calendar services to users of the enterprise. Access to the email service 107 can be federated to the 118/ in some examples. Users can utilize an email client or a user interface generated by the email service 107 to access email, calendar, contacts, and other data. Users can also create email messages, appointments, meetings, and perform other tasks. The email service 107 can also obtain work patterns 136 from the 121/ for respective users and provide the work patterns 136 to an email client. The work patterns 136 can be presented within the email client to a user attempting to schedule a meeting or event using a calendar feature provided by the email service 107.

The client device 106 can represent multiple client devices 106 coupled to the network 119. The client device 106 includes, for example, a processor-based computer system. According to various examples, a client device 106 can be in the form of a desktop computer, a laptop computer, a personal digital assistant, a mobile phone, a smartphone, or a tablet computer system. The client device 106 can represent a device that is owned or issued by the enterprise to a user, or a device that is owned by the user. The client device 106, when provisioned, can be enrolled with the management service 116 as a managed device of the enterprise.

The client device 106 can execute a management component 145 that can communicate with the management service 116 to facilitate management of the client device 106. The management component 145 can communicate with the management service 116 to enforce management policies and compliance rules on the client device 106. For example, the management component 145 can enforce data security requirements, install, remove or update security certificates, or write, modify or delete certain data from the client device 106. The management component 145 can also monitor network activity of the client device 106, the location of the client device 106, enforce password or personal identification number (PIN) requirements, or any other security or acceptable-use policies that are defined in the management service 116 and sent to the management component 145 over the network 119.

To carry out local management of a client device 106, the management component 145 can be installed and executed with elevated or administrative privileges on the client device 106. In some scenarios, the operating system can allow a particular application or package to be identified as a device owner or a device administrator.

One or more applications 147 can be installed on the client device 106. As a managed device that is enrolled with the management service 116, some applications 147 can be installed by the management service 116. In one scenario, the management service 116 can send a request to the management component 145 to retrieve and install a particular application 147 on the client device 106. In this sense, installation of the application is initiated by the management service 116. The management service 116 can also provide configuration data for a particular application 147 that it installed on the client device 106.

The application 147 can be a browser or incorporate browser functionality, such as a WebKit or WebView component, that allows the application 147 to access browser-based data. In some scenarios, the application 147 can be a special-purpose application that accesses data and services provided by a service. In some examples, an application 147 can be instrumented to provide usage data to the management service 116 or identity provider 118 when the application 147 is launched, during usage, and when a user may quit or log out of an application.

Another example of an application 147 can be an enterprise hub application or SSO application through which a user can authenticate his or her identity and access enterprise applications. Such an application can collect application usage data for applications associated with the enterprise and report the usage data to the management service 116 or the identity provider 118.

An email client 149 can also be installed on a client device 106 and utilized to access email data, calendar data, contacts, and other information accessible using an email client. The email client 149 can also obtain user availability from an email service 107. The user availability can be obtained in the form of a work pattern 136 for the user. The work pattern 136 can be requested by the email client 149 from the email service 107 for a particular time period that is being rendered within an email client 149.

A tunnel client 151 can be installed on a client device 106 to provide a VPN connection that is terminated at the tunnel server 120. The VPN connection can be an encrypted network connection that provides access to internal enterprise networks to the client device 106. The VPN connection, in some instances, can also simply encrypt network traffic between the client device 106 and the network 119 for security purposes. In some implementations, rather than utilizing a tunnel client 151 that sets up a VPN connection with the tunnel server 120, per-app VPN capabilities of an operating system of the client device 106 can be utilized.

According to examples of this disclosure, the availability detector 121 can generate a work pattern 136 that expresses a predicted work schedule of an enterprise user by analyzing application usage data as well as network usage data through network traffic detected using the tunnel client 151 or tunnel server 120. The application usage data can be detected using a hub application that provides access to enterprise applications installed on the client device 106 or that are hosted elsewhere. Application usage data can also be detected by analyzing user activity log data collected by the management service 116 and/or identity provider 118 corresponding to user logins, logouts, and application usage that can be detected or monitored on behalf of an enterprise.

A work pattern 136 can vary from user to user based upon variations in when users may opt to begin and end their respective workdays. A work pattern 136 can be utilized to generate an availability chart or availability user interface element in an email client 149. The user interface element can be generated such that times at which a user being requested for a meeting is likely available according to the work pattern 136 can be indicated in the user interface element, as can times where the user is likely unavailable.

A work pattern 136 can also be utilized by other processes and services for other purposes. For example, a work pattern 136 can be utilized to determine when, where, and to what extent VDI resources should be provisioned. For example, if a user is expected, based upon a work pattern 136, to begin working on a particular day and time, a VDI infrastructure service can withhold allocated the computing infrastructure for the user's VDI session until the user is expected to begin a workday according to the work pattern 136.

A work pattern 136 can vary depending upon the user, the day of the week, time of year, and evolve over time. Accordingly, the availability detector 121 can generate or update a work pattern 136 for a user periodically.

The availability detector 121 can obtain various inputs that reflect user activity to generate a work pattern 136. In one aspect, the availability detector 121 can obtain user activity data associated with network traffic between a client device 106 assigned to the user and a tunnel server 120 associated with the enterprise. Network traffic between a client device 106 and enterprise networks can reflect whether the user is active or not.

In another aspect, the availability detector 121 can obtain user activity data associated with the identity provider 118. Various applications and services are configured to utilize SSO and depend on the identity provider 118 API's for user authentication, providing authentication tokens, refresh tokens, and other authentication activity. In some cases, applications and services can communicate with the identity provider 118 whenever the user accesses the application. Accordingly, the identity provider 118 can generate usage logs for a respective user account within the enterprise. These usage logs can be provided to the availability detector 121, which can use the usage logs to generate a work pattern 136.

In another aspect, the availability detector 121 can obtain user activity data associated with application usage on a client device 106 of the user. In some examples, a management component 145 running on a client device 106 that is managed by the management service 116 can report application usage data to the management service 116. The application usage data can include the identity of applications as well as a timestamp associated with usage. The application usage data can also be reported by applications on the client device 106 to the management service 116. The availability detector 121 can generate a work pattern 136 based at least in part upon the usage data, the identity of applications (e.g., whether an application is a work application or a personal application) and timestamp data associated with the usage data.

In another aspect, the availability detector 121 can obtain user activity data associated with VDI usage by a user. In some examples, a VDI infrastructure environment can report VDI usage data to the management service 116 or the identity provider 118. The VDI usage data can include a timestamp associated with usage. The availability detector 121 can generate a work pattern 136 based at least in part upon the usage data.

In another aspect, the availability detector 121 can obtain user activity data associated with device usage of a client device 106 of the user. In some examples, a management component 145 or another application running on a client device 106 that is managed by the management service 116 can report device usage data to the management service 116. Device usage can include whether the screen is locked or not, whether a keyboard/mouse/tracking is in use, data from various device sensors to determine the user is using client device 106 or not. The availability detector 121 can generate a work pattern 136 based at least in part upon the device usage data.

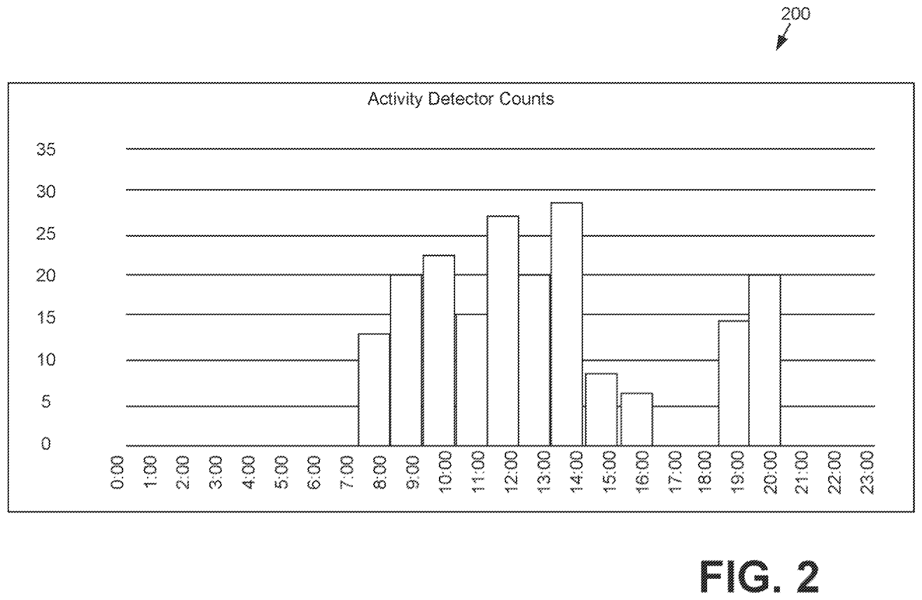

Referring next to FIG. 2, shown is an example of a graph 200 that can be generated by the availability detector 121. The graph 200 can represent activity detector counts that can be generated from the various forms of usage data that can be obtained by the availability detector 121. The activity detector counts can be sorted by a respective time of day, day of week, or other segment of time. Each segment of time can be associated with an activity level that can be a sum of user activity detected from the various usage data inputs. In some examples, the activity detector counts can be a weighted sum of user activity detected from the various usage data inputs. For example, certain usage data that has a higher confidence level of being associated with the user working can be assigned a higher weight. In one scenario, usage of one application can be assigned a higher weight than usage or another application or activity that is just network activity through the tunnel server 120.

In some examples, the availability detector 121 can utilize a machine learning process that can operate on the usage data to determine whether the user is working or not. The machine learning process can be trained on a set of usage data and the model can learn by incorporating whether a user accepts or declines a meeting invitation that is sent to the user. By declining a meeting invitation, the model can learn that the user is potentially not working and adjust the corresponding work pattern 136 for the user. By accepting a meeting invitation, the model can learn that the user is working and also adjust the corresponding work pattern 136.

Upon generating activity counts, the availability detector 121 can also quantize the activity counts. In some examples, the availability detector 121 can perform a quantization process that takes activity counts as an input and outputs a scaled value. In some examples, the availability detector 121 can filter out user activity that fails to meet an activity threshold, as some user activity might not be indicative of activity corresponding to an active user. For example, background network activity or low levels of user engagement with an application may signal that the user is not working.

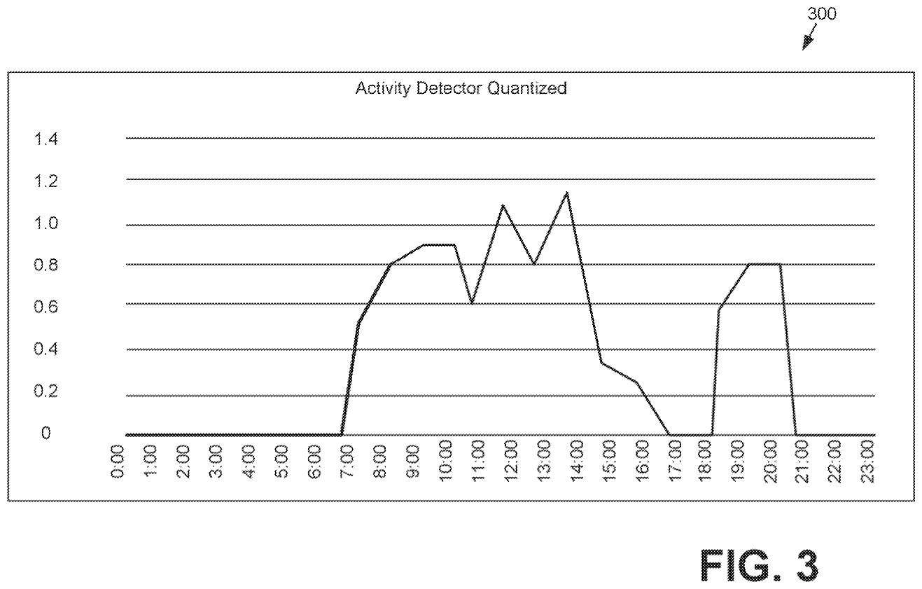

Referring next to FIG. 3, shown is an example graph 300 of quantized activity counts that can be generated by the availability detector 121. The quantized activity counts can be utilized to generate a heat map or a work pattern 136. In one example, a heat map can express different hours in the day along with a confidence score that a particular user is working. The heat map can be utilized by an email client 149, VDI infrastructure, or any other application or service to suggest meeting availability for a user, provision VDI resources, or provide access to other applications or services that are dependent upon whether the user is working or available.

In some examples, the quantized activity counts can represent a confidence score between zero and one that represents a likelihood that the user is working during a given time of a day. The scale of the confidence score can vary from a zero-to-one scale, and the above is just an example.

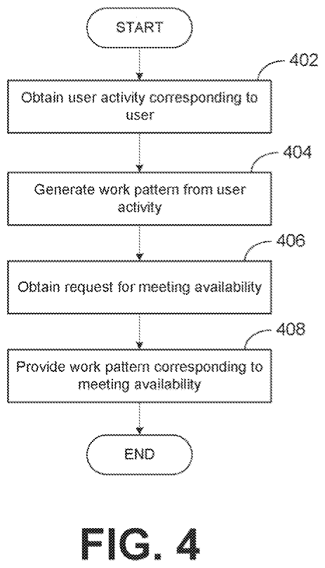

Referring next to FIG. 4, shown is a flowchart that provides one example of how the availability detector 121 can provide meeting availability, or a work pattern 136 to a requesting client, such as an email client 149. The work pattern 136 can also be utilized for other purposes, such as provisioning computing resources on behalf of the user or an enterprise.

At step 402, the availability detector 121 can obtain user activity corresponding to a user associated with an enterprise. The user activity can be usage data collected from various sources. The availability detector 121 can obtain user activity data associated with network traffic between a client device 106 assigned to the user and a tunnel server 120 associated with the enterprise. Network traffic between a client device 106 and enterprise networks can reflect whether the user is active or not.

In another aspect, the availability detector 121 can obtain user activity data associated with the identity provider 118. Various applications and services are configured to utilize SSO and depend on the identity provider 118 API's for user authentication, providing authentication tokens, refresh tokens, and other authentication activity. In some cases, applications and services can communicate with the identity provider 118 whenever the user accesses the application. Accordingly, the identity provider 118 can generate usage logs for a respective user account within the enterprise. These usage logs can be provided to the availability detector 121, which can use the usage logs to generate a work pattern 136.

In another aspect, the availability detector 121 can obtain user activity data associated with application usage on a client device 106 of the user. In some examples, a management component 145 running on a client device 106 that is managed by the management service 116 can report application usage data to the management service 116. The application usage data can include the identity of applications as well as a timestamp associated with usage. The application usage data can also be reported by applications on the client device 106 to the management service 116. The availability detector 121 can generate a work pattern 136 based at least in part upon the usage data, the identity of applications (e.g., whether an application is a work application or a personal application) and timestamp data associated with the usage data.

In another aspect, the availability detector 121 can obtain user activity data associated with VDI usage by a user. In some examples, a VDI infrastructure environment can report VDI usage data to the management service 116 or the identity provider 118. The VDI usage data can include a timestamp associated with usage. The availability detector 121 can generate a work pattern 136 based at least in part upon the usage data.

In another aspect, the availability detector 121 can obtain user activity data associated with device usage of a client device 106 of the user. In some examples, a management component 145 or another application running on a client device 106 that is managed by the management service 116 can report device usage data to the management service 116. Device usage can include whether the screen is locked or not, whether a keyboard/mouse/tracking is in use, data from various device sensors to determine the user is using client device 106 or not. The availability detector 121 can generate a work pattern 136 based at least in part upon the device usage data.

At step 404, the availability detector 121 can generate a work pattern 136 corresponding to the user activity. The work pattern 136 can be generated from activity detector counts that can be generated from the various forms of usage data that can be obtained by the availability detector 121. The activity detector counts can be sorted by a respective time of day, day of week, or other segment of time. Each segment of time can be associated with an activity level that can be a sum of user activity detected from the various usage data inputs. In some examples, the activity detector counts can be a weighted sum of user activity detected from the various usage data inputs. For example, certain usage data that has a higher confidence level of being associated with the user working can be assigned a higher weight. In one scenario, usage of one application can be assigned a higher weight than usage or another application or activity that is just network activity through the tunnel server 120.

In some examples, the availability detector 121 can generate quantized activity counts and/or a heat map that represent the work pattern 136 from the activity counts.

At step 406, the availability detector 121 can obtain a request for the work pattern 136 corresponding to a user. In some examples, the request can be a query from an email client 149 of a user attempting to invite the user to a meeting or event within the email client 149. In other examples, the work pattern 136 can be provided to an email service 107, a directory service, or any other service that may store user data such as the user's calendar or schedule.

At step 408, the availability detector 121 can provide the work pattern 136 to the requesting service. For example, the work pattern 136 can be provided to an email client 149, which can render the work pattern 136 in a user interface assisting the scheduling of a meeting or event using the email client 149. Thereafter, the process proceeds to completion.

The flowchart of FIG. 4 shows an example of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowchart of FIG. 4 shows a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The client device 106, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 116, identity provider 118, availability detector 121 and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All of these modifications and variations are intended to be included herein within the scope of this disclosure.

What is claimed is:

1. A system for multi-device single sign-on (SSO) comprising:
at least one computing device;
at least one application executed by the at least one computing device, wherein the at least one application causes the at least one computing device to at least:
obtain user activity corresponding to a user from at least one of a management service or an identity manager, the management service remotely managing a client device associated with the user and the identity manager comprising a single sign-on service associated with the user;
generate from the user activity a work pattern associated with the user;
obtain a request to query a meeting availability corresponding to the user, the query received from an email client; and
provide the work pattern associated with the user to the email client, wherein the email client displays the work pattern in a user interface.

2. The system of claim 1, wherein the at least one application generates the work pattern based upon network activity through a virtual private network (VPN) tunnel connection established between a client device of the user and a network associated with the management service.

3. The system of claim 1, wherein the at least one application generates the work pattern based upon usage activity associated with the identity manager.

4. The system of claim 3, wherein the usage activity associated with the identity manager comprises authentication with at least one service that has federated authentication to the identity manager.

5. The system of claim 1, wherein the user activity comprises application usage measured by a management component running on a client device associated with the user, wherein the management component reports application usage to the management service.

6. The system of claim 1, wherein the at least one application generates the work pattern by identifying respective user activity meeting an activity threshold that corresponds to respective times of day.

7. The system of claim 1, wherein the at least one application generates a heat map corresponding to the respective user activity, wherein the respective times of day corresponding to a highest respective user activity indicate a higher likelihood that the user is working at a respective time of day.

8. A non-transitory computer-readable medium comprising machine-readable instructions, wherein the instructions, when executed by at least one processor, cause a computing device to at least:
obtain user activity corresponding to a user from at least one of a management service or an identity manager, the management service remotely managing a client device associated with the user and the identity manager comprising a single sign-on service associated with the user;
generate from the user activity a work pattern associated with the user;
obtain a request to query a meeting availability corresponding to the user, the query received from an email client; and
provide the work pattern associated with the user to the email client, wherein the email client displays the work pattern in a user interface.

9. The non-transitory computer-readable medium of claim 8, wherein the instructions generate the work pattern based upon network activity through a virtual private network (VPN) tunnel connection established between a client device of the user and a network associated with the management service.

10. The non-transitory computer-readable medium of claim 8, wherein instructions generate the work pattern based upon usage activity associated with the identity manager.

11. The non-transitory computer-readable medium of claim 10, wherein the usage activity associated with the identity manager comprises authentication with at least one service that has federated authentication to the identity manager.

12. The non-transitory computer-readable medium of claim 8, wherein the user activity comprises application usage measured by a management component running on a client device associated with the user, wherein the management component reports application usage to the management service.

13. The non-transitory computer-readable medium of claim 8, wherein the instructions generate the work pattern by identifying respective user activity meeting an activity threshold that corresponds to respective times of day.

14. The non-transitory computer-readable medium of claim 8, wherein the instructions generate a heat map corresponding to the respective user activity, wherein the respective times of day corresponding to a highest respective user activity indicate a higher likelihood that the user is working at a respective time of day.

15. A method comprising:
obtaining user activity corresponding to a user from at least one of a management service or an identity manager, the management service remotely managing a client device associated with the user and the identity manager comprising a single sign-on service associated with the user;
generating from the user activity a work pattern associated with the user;
obtaining a request to query a meeting availability corresponding to the user, the query received from an email client; and
providing the work pattern associated with the user to the email client, wherein the email client displays the work pattern in a user interface.

16. The method of claim 15, further comprising generating the work pattern based upon network activity through a virtual private network (VPN) tunnel connection established between a client device of the user and a network associated with the management service.

17. The method of claim 15, further comprising generating the work pattern based upon usage activity associated with the identity manager.

18. The method of claim 17, wherein the usage activity associated with the identity manager comprises authentication with at least one service that has federated authentication to the identity manager.

19. The method of claim 15, wherein the user activity comprises application usage measured by a management component running on a client device associated with the user, wherein the management component reports application usage to the management service.

20. The method of claim 15, generate the work pattern by identifying respective user activity meeting an activity threshold that corresponds to respective times of day.
